(19) United States
(12) Patent Application Publication
(10) Pub. No.: US 2004/0032642 A1
(43) Pub. Date: Feb. 19, 2004

(54) Method and system for monitoring distributed raman optical transmission line

(76) Inventors: Kaoru Imai, Saitama (JP); Youko Kurosawa, Tokyo (JP); Noboru Edagawa, Saitama (JP); Haruhisa Sakata, Saitama (JP)

Correspondence Address: CHRISTIE, PARKER & HALE, LLP, P.O. BOX 7068, PASADENA, CA, 91109-7068, US

(21) Appl. No.: 10/641,934

(22) Filed: Aug. 14, 2003

(30) Foreign Application Priority Data
Aug. 15, 2002 (JP) 2002-236904

(51) Int. Cl. H01S 3/00

(52) U.S. Cl. 359/334

(57) ABSTRACT

A system for monitoring a distributed Raman optical transmission line to optically amplify a signal light having a signal wavelength by pumping with a Raman pumping light having a Raman pumping wavelength comprises an optical demultiplexer to demultiplex an output light from the distributed Raman optical transmission line into the signal wavelength component and the Raman pumping wavelength, an optical power measuring unit to measure the optical powers of the signal wavelength component and the Raman wavelength component demultiplexed by the optical demultiplexer, and a judging unit to judge whether a fault exists in the Raman amplification in the distributed Raman optical transmission line and the cause of the fault.

### CROSS REFERENCE TO RELATED APPLICATIONS

This application claims priority to Japanese Patent Application No. 2002-236904, filed Aug. 15, 2002, the entire contents of which are incorporated herein by reference.

### FIELD OF THE INVENTION

This invention relates to a method and system for monitoring a distributed Raman optical transmission line.

### BACKGROUND OF THE INVENTION

As a method to detect whether and where a fault exists in an optical transmission line in an optical fiber transmission system, a C-OTDR (Coherent Optical Time Domain Reflectometry) is well known. The C-OTDR is capable of specifying whether a fault exists and, if exists, where the fault is located by observing optical power of return light in time series, and therefore it is quite convenient to use.

As an optical amplifier repeater system, there are configurations to dispose an erbium-doped fiber amplifier (EDFA) at appropriate intervals, to use Raman amplification, and to use an EDFA and Raman amplification together.

In an optical amplifier repeater system using an EDFA, conventionally, a C-OTDR is employed to detect a fault in an optical transmission line, and accordingly it is possible to identify if a detected fault is located in the optical transmission line or in the other parts.

In an optical transmission line using Raman amplification, a C-OTDR cannot identify whether a detected fault is a fault in a cable or a fault in Raman pumping light only from an optical power level of return light.

### SUMMARY OF THE INVENTION

According to the invention, a method for monitoring a distributed Raman optical transmission line to optically amplify a signal light having a signal wavelength by pumping with a Raman pumping light having a Raman pumping wavelength comprises steps of demultiplexing an output light from the distributed Raman optical transmission line into the signal wavelength component and the Raman pumping wavelength component, measuring optical powers of the signal wavelength component and Raman pumping wavelength component demultiplexed in the demultiplexing step, and judging whether a fault exists in the Raman amplification in the distributed Raman optical transmission line and, if exists, the cause of the fault according to the changes of the optical powers of the signal wavelength component and Raman pumping wavelength component measured in the optical power measuring step.

According to the invention, a system for monitoring a distributed Raman optical transmission line to optically amplify a signal light having a signal wavelength by pumping with a Raman pumping light having a Raman pumping wavelength comprises an optical demultiplexer to demultiplex an output light from the distributed Raman optical transmission line into the signal wavelength component and the Raman pumping wavelength component, an optical power measuring unit to measure the optical power of the signal wavelength component and Raman pumping wavelength component demultiplexed by the optical demultiplexer, and a judging unit to judge whether a fault exists in the Raman amplification in the distributed Raman optical transmission line and, if exists, the cause of the fault according to the changes of optical powers of the signal wavelength component and Raman pumping wavelength component measured by the optical power measuring unit.

### BRIEF DESCRIPTION OF THE DRAWINGS

The above and other objects, features and advantages of the present invention will be apparent from the following detailed description of explanatory embodiments of the invention in conjunction with the accompanying drawings, in which:

FIG. 1 shows a schematic block diagram of a first explanatory embodiment according to the invention;

FIG. 2 shows a spectrum of light entered an optical repeater 14 from an optical fiber 12;

FIG. 3 is a flow chart of the operation of the first explanatory embodiment;

FIG. 4 is a detailed flow chart of the judging process (S5) for judging whether and where a fault exists;

FIG. 5 shows an example of changes of signal optical power Ps and Rayleigh scattered optical power Pr according to each cause of fault in backward pumping;

FIG. 6 shows a schematic block diagram of a modified version of the first explanatory embodiment;

FIG. 7 shows a schematic block diagram of a second explanatory embodiment according to the invention;

FIG. 8 shows an example of changes of the optical powers Ps and Pr according to each cause of fault in forward pumping;

FIG. 9 shows a schematic block diagram of a third explanatory embodiment according to the invention;

FIG. 10 shows an example of changes of the optical powers Ps and Pr according to each cause of fault in bidirectional pumping; and

FIG. 11 shows a schematic block diagram of a fourth explanatory embodiment according to the invention.

### DETAILED DESCRIPTION

Explanatory embodiments of the invention are explained below in detail with reference to the drawings.

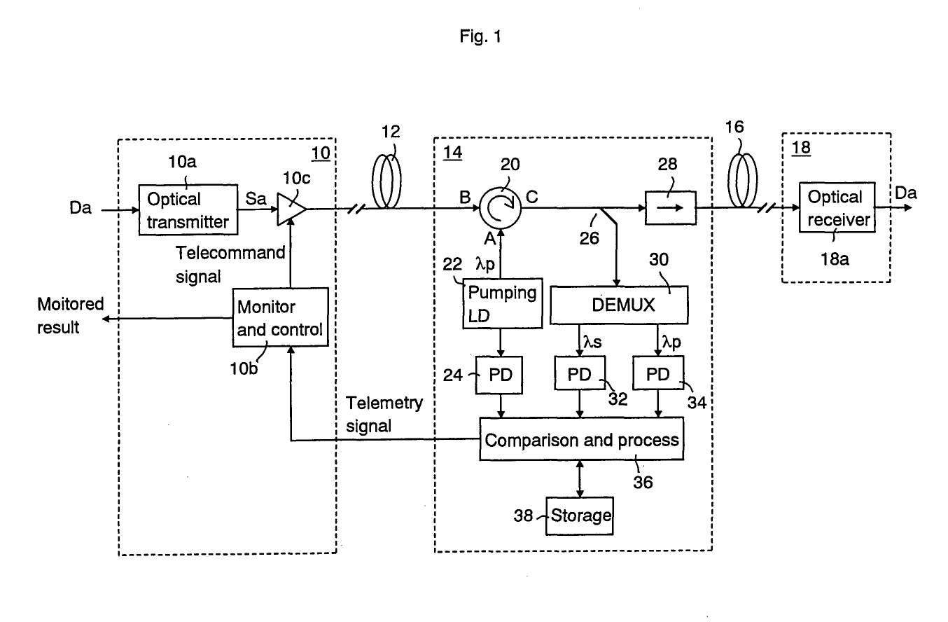

FIG. 1 shows a schematic block diagram of a first explanatory embodiment applied to an optical amplifier transmission line using Raman amplification in backward pumping.

A terminal station 10 connects to a terminal station 18 through an optical fiber 12 functioning as s Raman amplification medium, an optical repeater 14, and an optical fiber 16. The optical repeater 14 supplies Raman pumping light to the optical fiber 12. In FIG. 1, although a single optical repeater 14 is illustrated, in a long haul transmission system, a plurality of optical repeaters having the same configuration to that of the optical repeater 14 are disposed in an optical transmission line. Each optical repeater, similarly to the optical repeater 14, supplies Raman pumping light to an optical fiber in the upstream side.

In the terminal station 10, an optical transmitter 10a generates an optical signal Sa for carrying an input data Da. The optical signal Sa can be having either a single wavelength or a plurality of wavelengths. A monitor and control unit 10b outputs a telecommand signal for directing the optical repeater 14 to measure a status of the Raman amplification in the optical fiber 12. An optical amplifier 10c optically amplifies the optical signal Sa output from the optical transmitter 10a and, at the same time, functions as a variable gain optical amplifier whose gain is controlled by the telecommand signal as well. By modulating the gain slightly, the telecommand signal can be superposed on the optical signal Sa. Such method is well known. The output light from the optical amplifier 10c propagates in the optical fiber 12 and then enters the optical repeater 14.

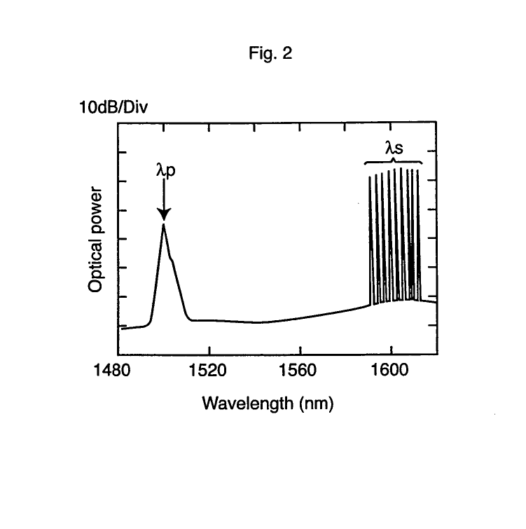

In the optical repeater 14, the light propagated in the optical fiber 12 enters a port A and outputs from a port B of an optical circulator 20. A laser diode (LD) 22 to function as a pumping light source generates a pumping light of wavelength λp for causing Raman amplification in the optical fiber 12. FIG. 2 shows a spectrum example of the light entered the optical repeater 14 from the optical fiber 12. The horizontal axis denotes wavelength and the vertical axis denotes optical power. In the example shown in FIG. 2, the signal light Sa comprises a WDM signal light of a 1600 nm band, and the wavelength λp of pumping light for the Raman amplification is approximately 1500 nm. In the spectrum shown in FIG. 2, the peak part of the wavelength λp contains Rayleigh scattered light in the Raman pumping light. As to be described later, in this embodiment, an optical power of this Rayleigh scattered light is monitored.

A photodetector 24 receives a power monitoring light output from the pumping LD 22 and converts the received light into an electrical signal. The pumping light output from the pumping LD 22 enters the port A of the optical circulator 20 and then enters the optical fiber 12 through the port B of the optical circulator 20. With this operation, Raman amplification occurs in the optical fiber 12, and accordingly the signal light Sa from the terminal station 10 is optically amplified.

An optical divider 26 applies most (e.g. 9/10 5or so) of the light output from a port C of the optical circulator 20, namely the light entered the optical repeater 14 from the optical fiber 12, to an optical isolator 28 and the rest (e.g. 1/10 or so) to an optical demultiplexer 30. The optical isolator 28 prevents a return light (e.g. scattered light and reflected light) from the optical fiber 16 and the pumping light from optical repeaters (not illustrated) in the rear from entering the inside of the optical repeater 14. The optical signal Sa (and the telecommand signal) passes through the optical isolator 28, propagates in the optical fiber 16, and enters the terminal station 18.

In the terminal station 18, an optical receiver 18a receives the optical signal Sa entered from the optical fiber 16 and decodes the data Da.

The optical demultiplexer 30 demultiplexes the input light into the component of signal light Sa and the component of Rayleigh scattered light of the Raman pumping light in the optical fiber 12. In the optical demultiplexer 30, most of optical powers of the incident light are composed of the component of signal light Sa and the component of Rayleigh scattered light of the Raman pumping light, and the other background lights are so weak that they can be neglected. Accordingly, the optical demultiplexer 30 can be any one of the optical filter that demultiplexes the incident light into the component of signal wavelength λs and the rest, the optical filter that demultiplexes the incident light into the component of Raman pumping wavelength λp and the rest, and the optical filter that demultiplexes the component of signal wavelength λs and the component of Raman pumping wavelength λp individually from the incident light.

A photodetector 32 converts the signal light component demultiplexed by the optical demultiplexer 30 into an electrical signal, a photodetector 34 converts the Rayleigh scattered light component into an electrical signal. The outputs from the photodetectors 32 and 34 enter a comparison and process unit 36. The output from the photodetector 24a also enters the comparison and process unit 36.

The comparison and process unit 36 analyzes a telecommand signal included in the output from the photodetector 32 and when the telecommand signal is indicating an initial state storing command, to store initial values (optical power in normal time) of each optical power in a storage unit 38 according to the photodetectors 24, 32, and 34 in normal state, and when the telecommand signal indicating a comparison and process command, to carry out the under-described comparison and process for transmitting the process result toward a monitor and control unit 10b.

The comparison and process unit 36 stores a pumping light power Pp, a signal light power Ps, and a Rayleigh scattered light power Pr in the storage unit 38 as normal light powers Ppn, Psn, and Prn according to the outputs from the photodetectors 24, 32, and 34 at the initial time when the Raman amplification in the optical fiber 12 is normally operating. When the comparison and process unit 36 receives the comparison and process command, it compares the current pumping light power Pp, signal light power Ps, and Rayleigh scattered light power Pr with the normal values Ppn, Psn, and Prn respectively, identifies whether there is a fault (an increase of loss) in the optical fiber 12 or a fault in the pumping light source 22 and its propagating route according to the compared results, and transmits the status information of the Raman amplification in the optical fiber 12 as the identified result, namely, the information indicating whether and where a fault exists to the monitor and control unit 10b. As one of the informing methods from the comparison and process unit 36 to the monitor and control unit 10b, there is, for example, a method to slightly modulate the gain of the signal light sent from the terminal station 12 to the terminal station 10 for multiplexing the information. The monitor and control unit 10b indicates the monitored result from the optical repeater 14 on the monitor screen or prints it out.

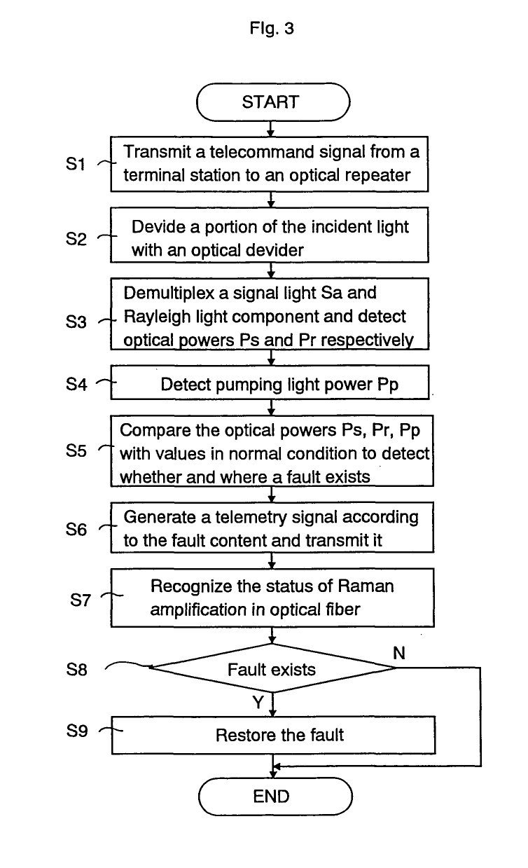

FIG. 3 shows a flow chart of the operation for monitoring a Raman amplification status in the optical fiber 12.

As described above, the terminal station 10 transmits the telecommand signal to the optical repeater 14 by multiplexing it on the optical signal Sa (S1).

In the optical repeater 14, as described above, the optical divider 26 branches a portion of the input light from the optical fiber 12 (S2). The optical demultiplexer 30 demultiplexes the input light into the signal light component Sa and the Rayleigh scattered light component of the Raman pumping light, and the comparison and process unit 36 detects the optical power Ps of the signal light component Sa and the optical power Pr of the Rayleigh scattered light component from the outputs from the photodetectors 32 and 34 respectively (S3) and also detects the Raman pumping light power Pp from the output from the photodetector 24 (S4). The optical power Ps of the signal light component and the optical power Pp of the pumping light can be either the peak power or the mean power.

The optical powers Ps, Pr, and Pp in the normal state in which the Raman amplification is normally operating in the optical fiber 12 are measured and stored respectively in the storage unit 40a in advance. The respective values in the normal state are shown as Psn, Prn, and Ppn.

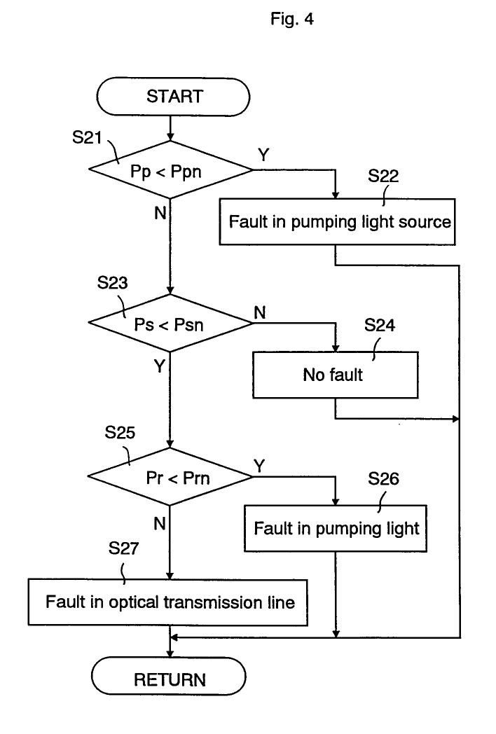

The comparison and process unit 36 compares the measured current light powers Ps, Pr, and Pp with the normal values Psn, Prn, and Ppn respectively and identifies whether a fault is in the transmission line or in the Raman pumping light according to the compared result (S5). The details of this identifying process are explained later referring to FIG. 4. At the step S5, the state is identified if a fault does not exist, a fault exists in the pumping light source 22, a fault exists in (a propagating route of) the pumping light, or a fault exists in the optical fiber 12. The faults referred here are minor faults such as deterioration of Raman amplification characteristics, rather than severe faults such as breaking of optical fibers.

The comparison and process unit 36 generates a telemetry signal according to the fault identification result to transmit it for the monitor and control unit 10b (S6). For instance, when an optical fiber transmission line for transmitting a signal light from the terminal station 18 to the terminal station 10 is disposed parallel to the optical fibers 12 and 16, as one of the methods to transmit a telemetry signal to the terminal station 10, a method to superpose the telemetry signal on the signal light to be transmitted from the terminal station 18 to the terminal station 10 is well known. The other signal transmission mediums also can be used.

The monitor and control unit 10b in the terminal station 10 analyzes the telemetry signal from the optical repeater 14 to identify the Raman amplification status in the optical fiber 12 (S7). As a result, when a fault is detected in the Raman amplification in the optical fiber 12 (S8), the monitor and control unit 10b urges the operator to perform operation for restoring the fault by informing the fault location (S9). If the fault restoring operation can be done automatically, the monitor and control unit 10b makes the subject equipment to perform the fault restoring operation.

FIG. 4 is a flow chart showing the process of the step S5, namely the identifying process in the comparison and process unit 36 to identify whether and where a fault exists. Here, Ppn, Psn, and Prn denote normal values of pumping light power, signal light power, and Rayleigh scattered light power respectively measured in advance. When the current light powers of Pp, Ps, and Pr are compared with the normal values of Ppn, Psn, and Prn respectively, a predetermined allowable error is considered.

First, it is identified if the Raman pumping light power Pp becomes lower than the normal value Ppn (S21). When the Raman pumping light power Pp is reduced compared to the normal value Ppn, it is judged that the pumping light source 22a has a fault (S22).

When the Raman pumping light power Pp is not lower than the normal value Ppn (S21), then the signal light power Ps is compared to the normal light power Psn (S23). When the signal light power Ps is not lower than the normal value Psn (S23), it is judged that the Raman amplification in the optical fiber 12 has no fault (S24).

When the signal light power Ps becomes lower than the normal value Psn (S23), the optical power Pr of the Rayleigh scattered light component of the Raman pumping light is compared to the normal value Prn (S25). When the optical power Pr of the Rayleigh scattered light component is lower than the normal value Prn (S25), it is judged that the fault is caused by the pumping light (S26), and when it is not lower than the normal value Prn (S25), it is judged that the fault exists in the optical fiber 12 (cable fault) (S27). The fault in the optical fiber 12 causes mainly the increase of transmission loss of the signal light. Breaks of the optical fiber 12 are informed from the other monitor system.

The faults regarding to the pumping light contain, in addition to a fault of the pumping light source 22, a fault of the photodetector 24, a fault in which the light output from the pumping light source 22 for monitoring optical power does not properly enter the photodetector 24, and a fault in which the optical circulator 20 can not properly transfer the output pumping light from the pumping light source 22 toward the optical fiber 12 and so on. Although the faults to be detected in the step S26 are mainly those cases wherein the output pumping light from the pumping light source 22 is not properly supplied to the optical fiber 12, the other faults regarding to the pumping light also can be detected.

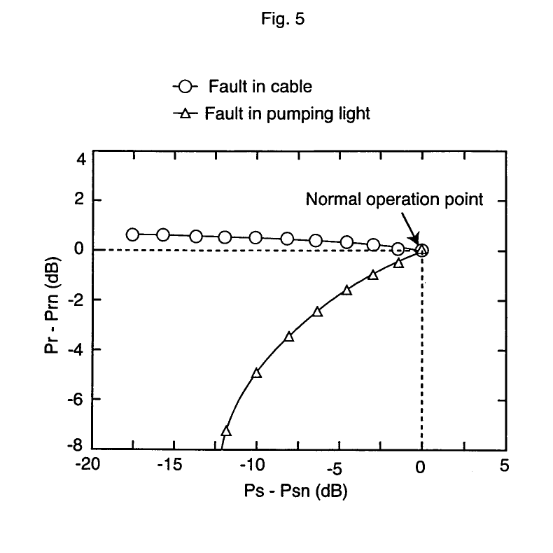

FIG. 5 shows measured results of how the signal light power Ps and Rayleigh scattering light power Pr vary according to whether a fault exists in the optical cable or in the pumping light source in backward pumping. The horizontal axis expresses the difference between the signal light power Ps and the normal signal light power Psn, and the vertical axis expresses the difference between the Rayleigh scattered light power Pr of the Raman pumping light and its normal light power Prn. FIG. 5 shows that the optical powers Ps and Pr express completely different variations depending on whether a fault exists in the cable or in the pumping light. That is, when a cable fault exists, although the signal light power Ps reduces, the optical power Pp of the Rayleigh scattered light slightly increases. On the other hand, when a pumping light fault exists, both signal light power Ps and Rayleigh scattering light power Pr decrease. When a fault of pumping light occurs, a pumping light is not supplied at all or just partly supplied to an optical fiber in which the pumping light functions as a Raman amplification medium and thus the Raman amplification does not occur to cause the decrease of the signal light power Ps and Rayleigh scattered light power Pr. In the embodiment, according to the above experimental result, a cable fault and a pumping light fault are identified in the process shown in FIG. 4.

When a plurality of optical fibers to function as Raman amplification mediums are disposed in serial between terminal stations 10 and 18, a Raman amplification state of each optical fiber is measured in order to begin with the optical fiber located nearest to the terminal station 18, namely measured from the optical fiber on the most downstream side toward the optical fiber on the most upstream side.

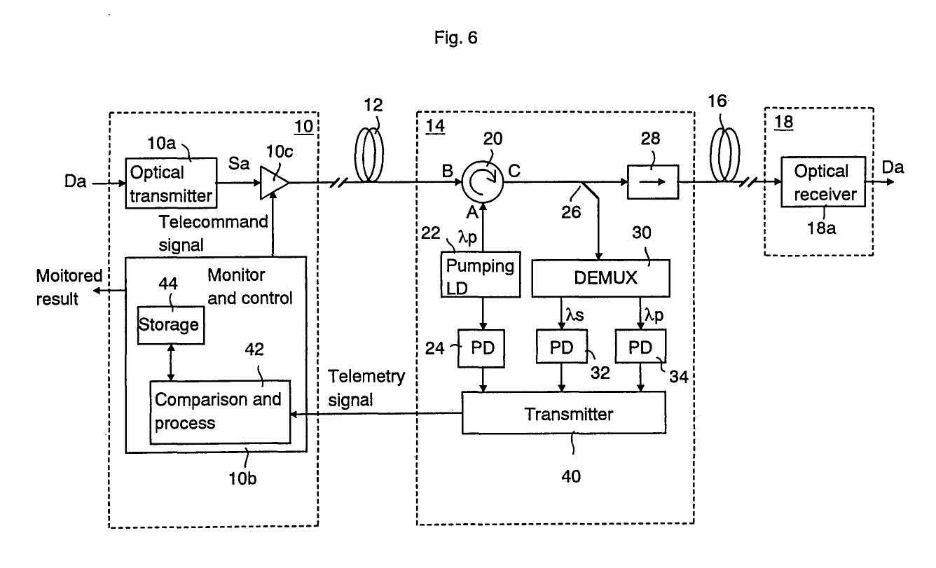

As a modified example of the embodiment shown in FIG. 1, it is applicable that the optical repeater 14 has a function only to transmit the measured optical powers Ps, Pr, and Pp and the monitor and control unit 10b in the terminal station 10 has roles of the comparison and process unit 36 and storage unit 38. FIG. 6 shows a schematic block diagram of such modified embodiment. In the modified embodiment shown in FIG. 6, a transmitter 40 in the optical repeater 14 transmits the outputs from the photodetectors 24, 32, and 34 to the monitor and control unit 10b in the terminal station 10. The monitor and control unit 10b comprises a comparison and process unit 42 having a function identical to the comparison and process unit 36 and a storage unit 44 having a function identical to the storage unit 38 and identifies whether and where a fault exists by comparing the measured current light powers Ps, Pr, and Pp with the normal light powers Psn, Prn, and Ppn respectively.

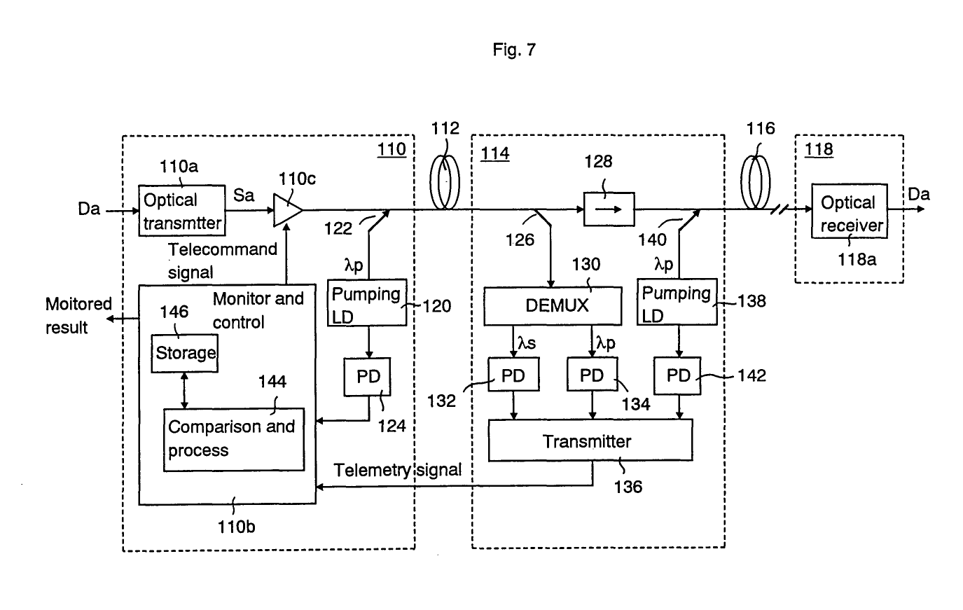

FIG. 7 shows a schematic block diagram of an embodiment to perform Raman amplification in forward pumping.

A terminal station 110 connects to a terminal station 118 through an optical fiber 112 as a Raman amplification medium, an optical repeater 114, and an optical fiber 116. The terminal station 110 supplies a Raman pumping light to the optical fiber 112. In a long haul optical transmission line, a plurality of optical repeaters having the same configuration with the optical repeater 114 are disposed in the optical transmission line.

In the terminal station 110, an optical transmitter 110a generates a signal light Sa for carrying an input data Da. The optical signal Sa can have either single wavelength or a plurality of wavelengths. The monitor and control unit 110b outputs a telecommand signal instructing the optical repeater 114 to measure status of Raman amplification in the optical fiber 112 on the upstream side. An optical amplifier 110c comprises a variable gain optical amplifier to optically amplify the signal light Sa output from the optical transmitter 110a and whose gain is controlled by the telecommand signal. By slightly modulating the gain, the telecommand signal can be superposed on the signal light Sa. Such method is well known.

The terminal station 110 further comprises a laser diode 120 which is a pumping light source for generating Raman pumping light of a wavelength λp to cause Raman amplification in the optical fiber 112. An optical combiner 122 combines the output light from the optical amplifier 110c and the output light from the pumping LD 120 and outputs the combined light for the optical fiber 112. A photodetector 124 receives a power monitoring output light from the pumping LD 120 and converts it into an electrical signal. The output from the photodetector 124 enters a monitor and control unit 110b.

In the optical fiber 112, the Raman amplification occurs pumped by the Raman pumping light from the pumping LD 120 to optically amplify the signal light Sa.

In the optical repeater 114, an optical divider 126 branches most (e.g. about 9/10) of the light entered the optical repeater 114 from the optical fiber 112 to an optical isolator 128 and the rest (e.g. about 1/10) to an optical demultiplexer 130. The optical isolator 128 prevents a return light (a scattered light and a reflected light) out of the rear optical elements, e.g. the optical fiber 116, from going up the stream. The signal light Sa (and a telecommand signal) passes through the optical isolator 128 and enters the terminal station 118 through the after-mentioned optical combiner 140 and optical fiber 116.

In the terminal station 118, an optical receiver 118a receives the signal light Sa from the optical fiber 116 and demodulates the data Da.

The optical demultiplexer 130 demultiplexes the input light into the component of signal light Sa and the component of Raman pumping wavelength λp. The component of wavelength λp contains the remainder of Raman pumping light not absorbed in the optical fiber 112 and the Rayleigh scattered light of the Raman pumping light in the optical fiber 112. Most of the optical powers of the incident light of the optical demultiplexer 130 consists of the component of signal light Sa and the component of Raman pumping wavelength λp, and the other background lights are so weak that they can be neglected. Accordingly, the optical demultiplexer 130, similarly to the optical demultiplexer 30, can be any one of optical filter that demultiplexes the component of signal wavelength λs and the rest from the incident light, optical filter that demultiplexes the component of Raman pumping wavelength λs and the rest from the incident light, and optical filter that demultiplexes the component of signal wavelength λs and the component of Raman pumping wavelength λp individually from the incident light.

A photodetector 132 converts the signal light component demultiplexed by the optical demultiplexer 130 into an electric signal, and a photodetector 134 converts the component of Raman pumping wavelength λp into an electric signal. The outputs from the photodetectors 132 and 134 enter a transmitter 136.

The optical repeater 114 further comprises a pumping LD 138 to generate a pumping light of wavelength λp to cause the Raman amplification in the optical fiber 116 in the rear. The wavelength of the output light from the pumping LD 138 is not required to strictly equal to the wavelength of the output light from the pumping LD 120. An optical combiner 140 combines the Raman pumping light output from the pumping LD 138 with the output light from the optical isolator 128 and outputs the combined light for the optical fiber 116. With this operation, the Raman amplification occurs in the optical fiber 116 and therefore the signal light Sa is optically amplified.

The photodetector 142 receives the power monitoring light output separately from the pumping LD 138 to convert into an electric signal. The output from the photodetector 142 is applied to the transmitter 136.

The transmitter 136 calculates the signal light power after the Raman amplification, the optical power of the Raman pumping wavelength component output from the Raman amplification medium, and the optical power of the Raman pumping light from the outputs of the photodetectors 132, 134, and 142 and transmits information indicating each optical power as a telemetry signal for the monitor and control unit 110b in the terminal station 110. The signal transmitting medium and method from the transmitter 136 to the monitor and control unit 110b can be identical to those in the above-mentioned embodiment and modified embodiment.

The monitor and control unit 110b comprises a comparison and process unit 144 and a storage unit 146, which operate similarly to the comparison and process unit 36 and the storage unit 38 in the first embodiment respectively. The monitor and control unit 110b transmits an initial state transmission command to each optical repeater 114 under the condition that the Raman amplification in the optical fibers 112 and 116 are normally operating so that each repeater 114 replies information indicating the optical power of signal light after the Raman amplification, the optical power of the component of Raman pumping wavelength λp output from the Raman amplification medium, and the optical power of the Raman pumping light, and the comparison and process unit 144 stores the information as optical power values in normal state into the storage unit 146.

In the monitoring operation, the comparison and process unit 144 compares the optical power Pp of the Raman pumping power in a subject optical fiber to be monitored, the optical power Ps of signal light output from the subject optical fiber, and the optical power Pr of the component of pumping wavelength λp output from the subject optical fiber with the respective normal optical powers so as to identify whether and where a fault exists. For instance, assuming that the subject fiber is the optical fiber 112, the comparison and process unit 144 compares the optical power Pp of the Raman pumping light in the optical fiber 112, the optical power Ps of signal light output from the optical fiber 112, and the optical power Pr of the component of pumping wavelength λp (the remained pumping light and its Rayleigh scattered light) output from the optical fiber 112 with the respective normal optical powers according to the outputs from the photodetectors 124, 132, and 134.

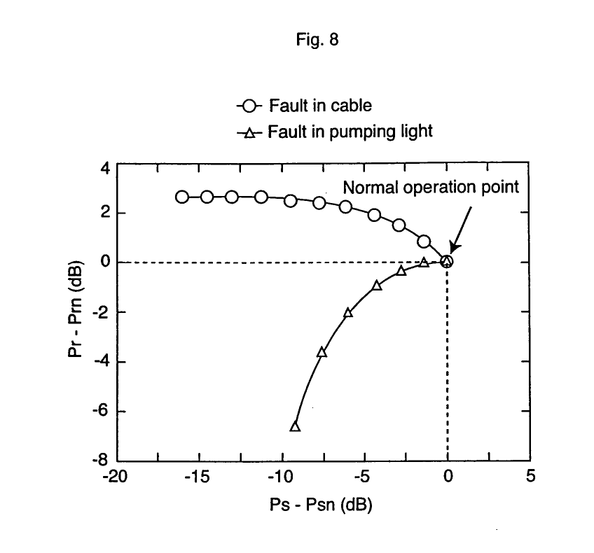

FIG. 8 shows variations of the optical powers Ps and Pr according to reasons of faults in forward pumping. The horizontal axis expresses the difference between the signal light power Ps and its normal value Psn, and the vertical axis expresses the difference between the optical power Pr of the component of Raman pumping wavelength λp output from the optical fiber to be monitored and its normal value Prn. As understandable from FIGS. 5 and 8, the forward pumping case shows a similar tendency toward a fault in backward pumping case. However, in forward pumping, the decrease of the pumping wavelength component due to a fault of the pumping light and the increase of the pumping wavelength component due to a fault of the cable are both more prominent compared to the backward pumping case.

Accordingly, in the forward pumping case, the algorithm of the comparison and process unit 144 to judge whether a fault exists and, if exists, whether the fault exists in the subject optical fiber or exists in the situation that the pumping light is not sufficiently supplied to the subject optical fiber is identical to the flowchart shown in FIG. 4. The threshold to determine a fault level is certainly different between the forward pumping and the backward pumping.

When a plurality of optical fibers to function as Raman amplification mediums are disposed in serial between the terminal stations 110 and 118, Raman states of the optical fibers are measured in order from the one located nearest to the terminal station 118, namely from the optical fiber on the most downstream side toward the optical fiber on the most upstream side.

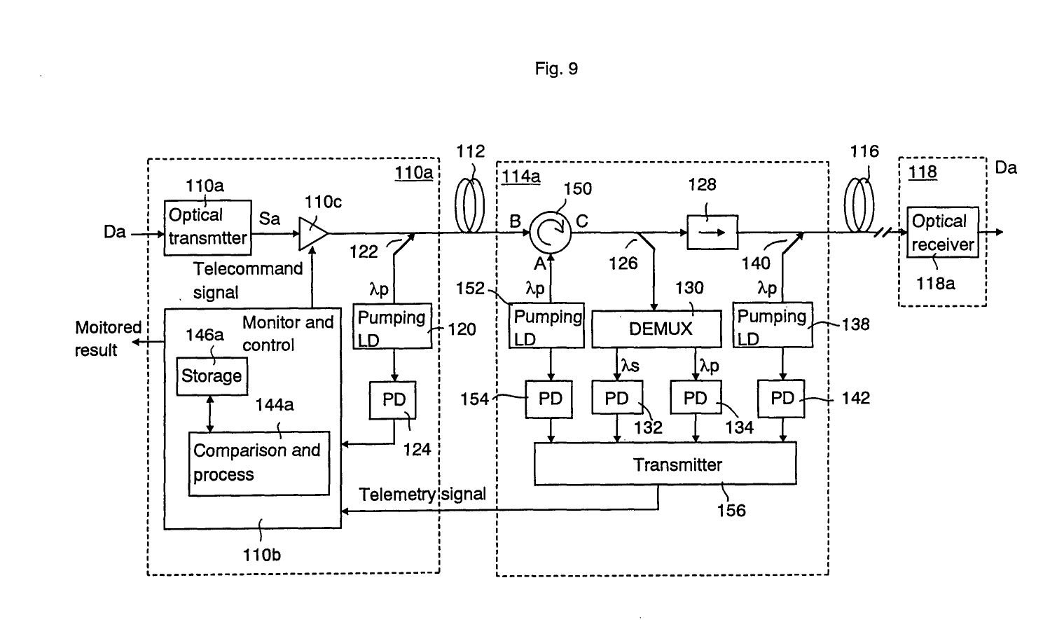

FIG. 9 shows a schematic block diagram of an embodiment in bidirectional pumping. The configuration shown in FIG. 9 is the one in which a pumping light source of backward pumping is added to the configuration in forward pumping shown in FIG. 7. That is, in the optical repeater 114a, an optical circulator 150, pumping LD 152, and a photodetector 154 corresponding respectively to the optical circulator 20, pumping LD 22, and photodetector 24 are added, and a transmitter 156 is disposed instead of the transmitter 136. The transmitter 156 transmits information of each divider to the monitor and control unit 144a in the terminal station 110a according to the outputs from the photodetectors 132, 134, 142, and 154.

A comparison and process unit 158 and a storage unit 160 operate similarly to the comparison and process unit 144 and the storage unit 146 respectively. That is, the value of each optical power in the normal Raman amplification state is stored in the storage unit 160. The comparison and process unit 158, similarly to the comparison and process unit 144, refers the normal value of optical power stored in the storage unit 160 and compares each current optical power with the corresponding normal light power to judge whether and where a fault of the Raman amplification exists in the optical fiber 112.

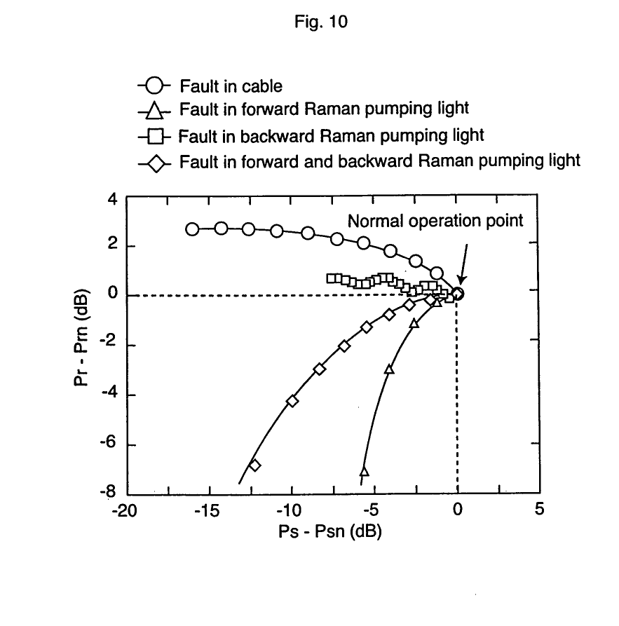

FIG. 10 shows variations of optical powers Ps and Pr according to a fault difference in bidirectional pumping. The horizontal axis expresses the difference between the signal light power Ps and its normal value Psn, and the vertical axis expresses the difference between the optical power Pr of the component of Raman pumping wavelength λp output from a subject optical fiber to be monitored and its normal value Prn. In the bidirectional pumping, there are three types of faults in pumping light, namely the one in the forward pumping, the one in the backward pumping, and the one in both pumping.

When it is a fault of pumping light in the backward pumping, although the signal light power Ps decreases, the optical power Pr does not change much. In other words, when the signal light power Ps decreases and the optical power Pr does not vary, it is assumed that the fault exists either in the pumping LD 152 in the backward pumping or in the transmission path in which the pumping light output from the pumping LD 152 propagates toward the optical fiber 112.

When a plurality of optical fibers to function as Raman amplification mediums are disposed in serial between the terminal stations 110 and 118, a Raman amplification state of each optical fiber is measured in order from the optical fiber nearest to the terminal station 118, namely from the optical fiber on the most downstream side toward the optical fiber on the most upstream side.

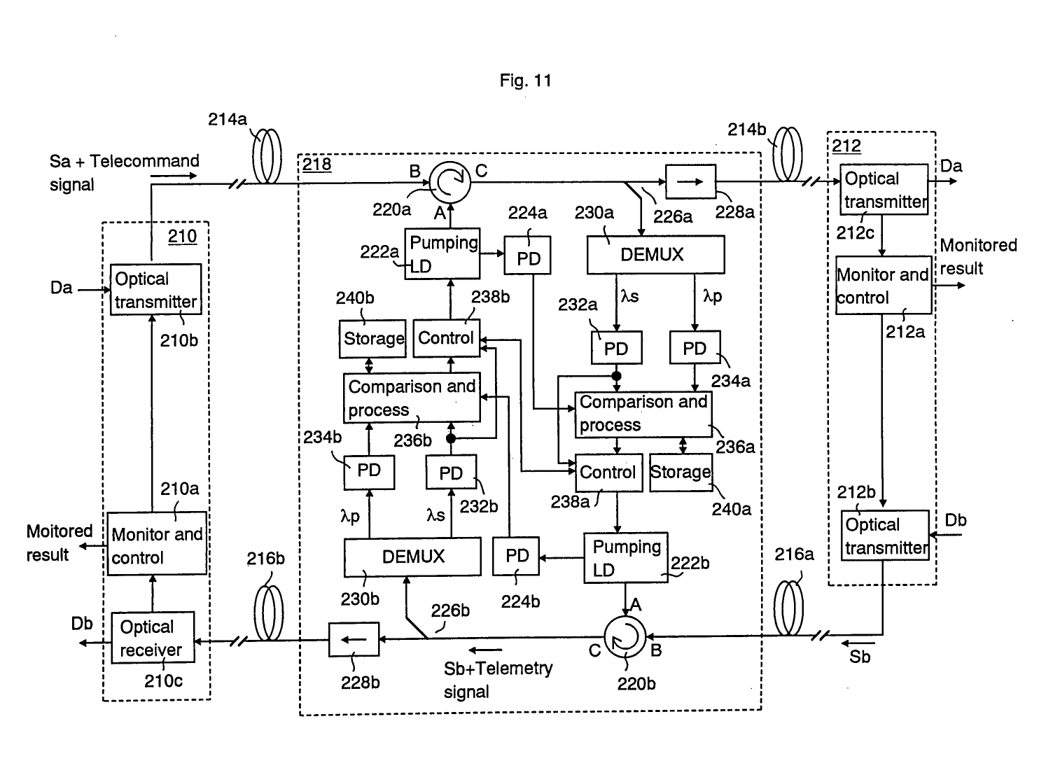

FIG. 11 shows a schematic block diagram of an embodiment in backward pumping in which main apparatuses for monitoring the Raman amplification are disposed in an optical repeater, and a monitor and control unit for controlling the optical repeater and receiving a judged result regarding whether and where a fault exists from the optical repeater is disposed in a terminal station.

Optical fibers 214a, 214b, 216a, and 216b and an optical repeater 218 are disposed between terminal stations 210 and 212. That is, a signal light Sa output from the terminal station 210 enters the terminal station 212 through the optical fiber 214a, optical repeater 218, and optical fiber 214b. Similarly, a signal light Sb output from the terminal station 212 enters the terminal station 210 through the optical fiber 216a, optical repeater 218, and optical fiber 216b. In the real system, although a plurality of optical repeaters identical to the optical repeater 218 are disposed in serial between the terminal stations 210 and 212, in FIG. 11, only the single optical repeater 218 is illustrated as a representative. In the embodiment, the optical fibers 214a and 216a function as optical amplification mediums to cause the Raman amplification.

In the embodiment, the terminal station 210 superimposes a telecommand signal to remotely control the optical repeater 218 on a WDM signal light Sa carrying a data Da and outputs the superimposed signal light for the optical fiber 214a. The signal light on which the telecommand signal was superimposed propagates in the optical fiber 214a and enters the optical repeater 218. The optical repeater 218 monitors and controls the Raman amplification in the optical fiber 214a according to the telecommand signal from the terminal station 210 and transmits a telemetry signal indicating a monitored and controlled result toward the terminal station 210 by superimposing the information on a WDM signal light Sb transferred toward the terminal station 210 from the terminal station 212.

The terminal station 212 superimposes a telecommand signal to remotely control the optical repeater 218 on the WDM signal light Sb carrying a data Db and outputs the superimposed signal light for the optical fiber 216a. The WDM signal light Sb on which the telecommand signal was superimposed propagates in the optical fiber 216a and enters the optical repeater 218. The optical repeater 218 monitors and controls the Raman amplification in the optical fiber 216a according to the telecommand signal from the terminal station 212 and transmits a telemetry signal indicating a monitored and controlled result toward the terminal station 212 by superimposing the information on the WDM signal light Sa transferred toward the terminal station 212 from the terminal station 210.

The terminal station 210 comprises a monitor and control unit 210a for generating a telecommand signal to instruct the optical repeater 218 to monitor and control the Raman amplification in the optical fiber 214a, an optical transmitter 210b for generating a WDM signal light Sa for carrying an input data Da and for superimposing the telecommand signal from the monitor and control unit 210a on the WDM signal light Sa to output it for the optical fiber 214a, and an optical receiver 210c for receiving the light input from the optical fiber 216b to restore and output the data Db and for supplying the telemetry signal to be superimposed on the signal light Sb for the monitor and control unit 210a.

The terminal station 212 has the same structure as that of the terminal station 210, and comprises a monitor and control unit 212a to generate a telecommand signal for instructing the optical repeater 218 to monitor and control the Raman amplification in the optical fiber 216a, an optical transmitter 212b to generate a WDM signal light Sb for carrying an input data Db and to superimpose the telecommand signal from the monitor and control unit 212a on the WDM signal light Sb to output it for the optical fiber 216a, and an optical receiver 212c to restore and output the data Da from the WDM signal light Sa input from the optical fiber 214b and to supply the telemetry signal superimposed on the optical signal Sa to the monitor and control unit 212a.

The configuration and operation of the optical repeater 218 are described below in detail. The light which has propagated in the optical fiber 214a enters a port A and outputs from a port B of an optical circulator 220a. A pumping LD 222a, that is, a Raman pumping light source, generates a pumping light of wavelength λp to cause the Raman amplification in the optical fiber 214a. A photodetector 224a receives a power monitoring light output from the pumping LD 222a to convert into an electrical signal. The pumping light output from the pumping LD 222a enters the port A of the optical circulator 220a to be supplied to the optical fiber 214a through the port B. With this operation, the optical fiber 214a optically amplifies the signal light Sa from the terminal station 210 using the Raman amplification in backward pumping.

An optical divider 226a applies most (e.g. about 9/10) of the light output from a port C of the optical circulator 220 to an optical isolator 228a and the rest (e.g. 1/10 or so) to an optical demultiplexer 230a. The optical isolator 228a prevents a return light (e.g. scattered light and reflected light) from the optical fiber 214b and the pumping light from optical repeaters (not illustrated) in the rear from entering the inside of the optical repeater 218. The signal light Sa (and the telecommand signal) passes through the optical isolator 228a and enters the optical fiber 214b.

The optical demultiplexer 230a, similarly to the optical demultiplexer 30, demultiplexes the input light into the component of signal light Sa and the component of the wavelength λp (the Rayleigh scattered light component of Raman pumping light in the optical fiber 154a) and extracts them separately.

The photodetector 232a converts the signal light component demultiplexed by the optical demultiplexer 230a into an electrical signal and the photodetector 234a converts the light component of wavelength λp demultiplexed by the optical demultiplexer 230a into an electrical signal. Outputs from the photodetectors 232a and 234a enter a comparison and process unit 236a and the output from the photodetector 232a enters a controller 238a as well. In addition, output from the photodetector 224a enters the comparison and process unit 236a.

The controller 238a analyzes the telecommand signal included in the output from the photodetector 232a and controls the comparison and process unit 236a and the pumping LD 222b according to the analyzed result. Furthermore, the controller 238a transmits/receives a variety of data to/from a controller 238b and therefore can control the comparison and process unit 236b and the pumping LD 222a through the controller 238b.

The comparison and process unit 236a compares the pumping light power Pp, signal light power Ps, and Rayleigh scattered light power Pr with their normal values respectively according to the outputs from the photodetectors 224a, 232a, and 234a and identifies a fault in the optical fiber 214a from faults of the pumping light source 222a and its propagating path. The comparison and process unit 236a has basically the same operation as that of the comparison and process unit 36. The comparison and process unit 236a stores the optical powers Pp, Ps, and Pr obtained when the Raman amplification in the optical fiber 212 is normally operating as normal values Ppn, Psn, and Prn in a storage unit 240a. The comparison and process unit 236a informs status information of the Raman amplification in the optical fiber 214a, namely the information indicating whether and where a fault exists, to the controller 238a.

The status information of the Raman amplification in the optical fiber 214a is superimposed on the WDM signal light Sb propagating toward the terminal station 210 from the terminal station 212 by modulating the gain of Raman amplification in the optical fiber 216a and sent to the terminal station 210. That is, the controller 238a modulates the power of the pumping light output from the pumping LD 222b according to the status information of the Raman amplification in the optical fiber 214a. The pumping light output from the pumping LD 222b enters a port A of an optical circulator 220b and outputs to the optical fiber 216a from a port B of the optical circulator 220b. The terminal station 212 applies a WDM signal light Sb destined for the terminal station 210 to the optical fiber 216a, and the WDM signal light Sb in the optical fiber 216a is Raman-amplified by the pumping light output from the pumping LD 222b. With this operation, the status information (the telemetry signal) of the Raman amplification in the optical fiber 214a is superimposed on the WDM signal light Sb. The Raman amplified WDM signal light Sb enters the port B of the optical circulator 220b and then enters an optical isolator 228b through a port C of the optical circulator 220b.

The optical isolator 228b prevents a return light (e.g. scattered light and reflected light) from the optical fiber 216b and the pumping lights from optical repeaters (not illustrated) disposed between the terminal station 210 and the optical repeater 218 from entering inside the optical repeater 218. The WDM signal light Sb and the telemetry signal pass trough the optical isolator 228b and enter the optical fiber 216b.

The WDM signal light Sb and the telemetry signal propagated in the optical fiber 216b enter the optical receiver 210c in the terminal station 210. The optical receiver 210c restores the data Db carried by the WDM signal light Sb out of the light input from the optical fiber 216b and outputs the restored data Db. The optical receiver 210c also restores the telemetry signal (the status information of the Raman amplification in the optical fiber 214a) superimposed on the WDM signal light Sb and applies the restored telemetry signal to the monitor and control unit 210a. The monitor and control unit 210a outputs the status information from the optical receiver 210c toward the outside and, as the need arises, generates a telecommand signal to remotely control the optical repeater 218 and applies it to the optical transmitter 210b.

The WDM signal light Sa (and the telecommand signal) entered the optical fiber 214b from the optical isolator 228a propagates in the optical fiber 214b and enters the optical receiver 212c in the terminal station 212. The optical receiver 212c restores the data Da carried by the WDM signal light Sa out of the light input from the optical fiber 214b and outputs the restored data Da.

The configuration and operation of the optical repeater 218 to monitor the Raman amplification status in the optical fiber 216a are substantially identical to those of the above-described embodiment for monitoring the Raman amplification status in the optical fiber 214a. That is, a photodetectors 224b, an optical divider 226b, an optical isolator 228b, an optical demultiplexer 230b, photodetectors 232b and 234b, a comparison and process unit 236b, a controller 238b, and a storage unit 240b operate in the same way as the aforementioned operations of the photodetector 224a, the optical divider 226a, the optical isolator 228a, the optical demultiplexer 230a, the photodetectors 232a and 234a, the comparison and process unit 236a, the controller 238a, and the storage unit 240a.

There is a possibility that the Raman amplification status information in the optical fiber 216a is superimposed on the WDM signal light Sa which enters the optical receiver 212c from the optical fiber 214b. In such case, the optical receiver 212c applies the status information to the monitor and control unit 212a. The monitor and control unit 212a outputs the status information from the optical receiver 212c toward the outside and, as the need arises, generates a telecommand signal to remotely control the optical repeater 218 and applies it to the optical transmitter 212b.

In the embodiment, the controllers 236a and 236b can mutually communicate information and therefore it is possible to transmit the status information of the Raman amplification in the optical fiber 214a to the terminal station 212. Similarly, the status information of the Raman amplification in the optical fiber 216a can be transmitted to the terminal station 210.

To make it easy to understand the function of the embodiment, although the comparison and process unit 236a, the controller 238a, and the storage unit 240a are shown in the separate function blocks, those functions can be realized in a single microcomputer. Similarly, the parts of the comparison and process unit 236b, controller 238b, and storage unit 240b can be realized in a single microcomputer. Furthermore, it is easy to realize the functions of the comparison and process unit 236a, controller 238a, storage unit 240a, comparison and process unit 236b, controller 238b, and storage unit 240b using a single microcomputer.

The judging algorism for judging whether and where a fault of the Raman amplification exists in the optical fiber 214a, 216a is identical to that explained in the embodiment shown in FIG. 1 and thus the explanation about it is omitted.

As readily understandable from the aforementioned explanation, according to the invention, it is possible to identify whether a fault (e.g. a deterioration of amplifying characteristics) of a Raman amplification optical transmission medium exists and, if exists, where the fault is located or why the fault is occurred. That is, it is easily identified whether it is a fault of an optical transmission medium (e.g. increase of loss) or a fault of Raman pumping light (e.g. a fault of a pumping light source and transmission fault of a pumping light etc.) and accordingly it is possible to take appropriate steps to meet the situation.

While the invention has been described with reference to the specific embodiment, it will be apparent to those skilled in the art that various changes and modifications can be made to the specific embodiment without departing from the spirit and scope of the invention as defined in the claims.

1. A method for monitoring a distributed Raman optical transmission line to optically amplify a signal light having a signal wavelength by pumping with a Raman pumping light having a Raman pumping wavelength, the method comprising steps of:
demultiplexing an output light from the distributed Raman optical transmission line into the signal wavelength component and the Raman pumping wavelength component;
measuring divider of the signal wavelength component and Raman pumping wavelength component demultiplexed in the demultiplexing step; and
judging whether a fault exists in the Raman amplification in the distributed Raman optical transmission line and, if exists, the cause of the fault according to the changes of the optical powers of the signal wavelength component and Raman pumping wavelength component measured in the optical power measuring step.

2. The method of claim 1 wherein the judging step judges that it is a line fault in the distributed Raman optical transmission line when the optical power of the signal wavelength component decreases and the optical power of the Raman pumping wavelength component increases, and that it is a fault in the Raman pumping light when both dividers of the signal wavelength component and Raman pumping wavelength component decrease.

3. The method of claim 1 wherein the Raman pumping light is supplied forward and backward to the distributed Raman optical transmission line; and
the judging step judges that it is a line fault in the distributed Raman optical transmission line when the optical power of the signal wavelength component decreases and the optical power of the Raman pumping wavelength component increases, that it is a fault in the Raman pumping light when both divider of the signal wavelength component and Raman pumping wavelength component decrease, and that it is a fault in the Raman pumping light supplied forward to the distributed Raman optical transmission line when the optical power of the signal wavelength component decreases and the optical power of the Raman pumping wavelength component practically does not change.

4. The method of claim 1 wherein the judging step comprises steps of;
storing both dividers of the signal wavelength component and Raman pumping wavelength component measured in the optical power measuring step when the Raman amplification in the distributed Raman optical transmission line was normal in a storage unit; and
comparing the optical power of the signal wavelength component and the optical power of the Raman pumping wavelength component measured in the optical power measuring step with the values stored in the storage unit respectively to judge whether a fault exists in the Raman amplification in the distributed Raman optical transmission line and, if exists, the cause of the fault.

5. The method of claim 4 wherein the comparing step judges that it is a line fault in the distributed Raman optical transmission line when the optical power of the signal wavelength component becomes lower than the optical power of the signal wavelength component stored in the storage unit and the optical power of the Raman pumping wavelength becomes higher than the optical power of the Raman pumping wavelength stored in the storage unit and that it is a fault in the Raman pumping light when optical powers of the signal wavelength component and Raman pumping wavelength component become lower than the optical powers of the signal wavelength component and the Raman pumping wavelength component stored in the storage unit respectively.

6. The method of claim 4 wherein the Raman pumping light is supplied forward and backward to the distributed Raman optical transmission line; and
the comparing step judges that it is a line fault in the distributed Raman optical transmission line when the optical power of the signal wavelength component becomes lower than the optical power of the signal wavelength component stored in the storage unit and the optical power of the Raman pumping wavelength component becomes higher than the optical power of the Raman pumping wavelength component stored in the storage unit, that it is a fault in the Raman pumping light when the optical powers of the signal wavelength component and Raman pumping wavelength component become lower than the optical powers of the signal wavelength component and Raman pumping wavelength component stored in the storage unit respectively, and that it is a fault in the Raman pumping light supplied forward to the distributed Raman optical transmission line when the optical power of the signal wavelength component becomes lower than the optical power of the signal wavelength component stored in the storage unit and the optical power of the Raman pumping wavelength component does not practically change from the optical power of the Raman pumping wavelength component stored in the storage unit.

7. A system for monitoring a distributed Raman optical transmission line to optically amplify a signal light having a signal wavelength by pumping with a Raman pumping light having a Raman pumping wavelength, the system comprising:
an optical demultiplexer to demultiplex an output light from the distributed Raman optical transmission line into the signal wavelength component and the Raman pumping wavelength,
an optical power measuring unit to measure the optical powers of the signal wavelength component and the Raman wavelength component demultiplexed by the optical demultiplexer, and
a judging unit to judge whether a fault exists in the Raman amplification in the distributed Raman optical transmission line and the cause of the fault.

8. The system of claim 7 wherein the judging unit judges that it is a line fault in the distributed Raman optical transmission line when the optical power of the signal wavelength component decreases and the optical power of the Raman pumping wavelength component increases and that it is a fault in the Raman pumping light when both dividers of the signal wavelength component and Raman pumping wavelength component decrease.

9. The system of claim 7 wherein the Raman pumping light is supplied forward and backward to the distributed Raman optical transmission line; and
the judging unit judges that it is a line fault in the distributed Raman optical transmission line when the optical power of the signal wavelength component decreases and the optical power of the Raman pumping wavelength component increases, that it is a fault in the Raman pumping light when both dividers of the signal wavelength component and Raman pumping wavelength component decrease, and that it is a fault in the Raman pumping light supplied forward to the distributed optical transmission line when the optical power of the signal wavelength component decreases and the optical power of the Raman pumping wavelength component practically does not change.

10. The system of claim 7 wherein the judging unit comprises;
a storage unit to store both dividers of the signal wavelength component and Raman pumping wavelength component measured by the optical power measuring unit when the Raman amplification in the distributed Raman optical transmission line is normal; and
a comparator to compare the optical powers of the signal wavelength component and the optical power of the Raman pumping wavelength component measured by the optical power measuring unit with the values stored in the storage unit respectively to judge whether a fault exists in the Raman amplification in the distributed Raman optical transmission line and, if exists, the cause of the fault.

11. The system of claim 10 wherein the comparator judges that it is a line fault in the distributed Raman optical transmission line when the optical power of the signal wavelength component becomes lower than the optical power of the signal wavelength component stored in the storage unit and the optical power of the Raman pumping wavelength becomes higher than the optical power of the Raman pumping wavelength stored in the storage unit and that it is fault in the Raman pumping light when both dividers of the signal wavelength component and Raman pumping wavelength component become lower than the optical powers of the signal wavelength component and the Raman pumping wavelength component stored in the storage unit respectively.

12. The system of claim 10 wherein the Raman pumping light is supplied forward and backward to the distributed Raman optical transmission line; and
the comparator judges that it is a line fault in the distributed Raman optical transmission line when the optical power of the signal wavelength component becomes lower than the optical power of the signal wavelength component stored in the storage unit and the optical power of the Raman pumping wavelength component becomes higher than the optical power of the Raman pumping wavelength component stored in the storage unit, that it is a fault in the Raman pumping light when both optical powers of the signal wavelength component and Raman pumping wavelength component become lower than the optical powers of the signal wavelength component and Raman pumping wavelength component stored in the storage unit respectively, and that it is a fault in the Raman pumping light supplied forward to the distributed Raman optical transmission line when the optical power of the signal wavelength component becomes lower than the optical power of the signal wavelength component stored in the storage unit and the optical power of the Raman pumping wavelength component does not practically change from the optical power of the Raman pumping wavelength component stored in the storage unit.
